(19) United States
(12) Patent Application Publication
(10) Pub. No.: US 2022/0084082 A1
(43) Pub. Date: Mar. 17, 2022

(54) SYSTEM AND METHOD FOR OPERATING REVIEW-AND-MAKE-MONEY PLATFORM

(71) Applicants: Sang Yong YI, Seoul (KR); Sang Ho LEE, Seoul (KR)

(72) Inventors: Sang Yong YI, Seoul (KR); Sang Ho LEE, Seoul (KR)

(21) Appl. No.: 17/224,446

(22) Filed: Apr. 7, 2021

(30) Foreign Application Priority Data
Sep. 15, 2020 (KR) 10-2020-0118633

(51) Int. Cl. G06Q 30/02; G06Q 20/10; G06Q 30/00

(52) U.S. Cl. CPC G06Q 30/0282; G06Q 30/018; G06Q 20/102

(57) ABSTRACT

Provided is a system for operating review-and-make-money platform (RAMM) including a review posting unit configured to receive a reviewer review, provide the received reviewer review to a consumer terminal, and display the reviewer review on a review article posting screen of the consumer terminal, a review evaluation unit configured to collect and index a consumer evaluation for the displayed review and manage a review satisfaction and a reviewer reliability index, and a priority adjustment unit configured to determine exposure ranking for each review article based on at least one of the review satisfaction and the reviewer reliability index managed by the review evaluation unit.

### CROSS-REFERENCE TO RELATED APPLICATION

This application claims priority under 35 U.S.C. § 119 to Korean Patent Application No. 10-2020-0118633, filed on Sep. 15, 2020, in the Korean Intellectual Property Office the disclosure of which is incorporated herein by reference in its entirety.

### BACKGROUND

### 1. Field of the Invention

The present disclosure relates to a platform operation to increase sales.

### 2. Description of Related Art

Modern people select products and services to purchase in a variety of ways such as advertisements, product introductions of influencers, shopping mall searches, offline window shopping, introduction by acquaintances, and user reviews.

However, the results are not always good compared to the time and effort it takes to purchase products and services.

Modern people are always exposed to exaggerated advertisements, fraudulent advertisements, manipulation of reviews, manipulation of public opinion, or the like and do not have the means to filter out the advertisements or manipulations.

### SUMMARY OF THE INVENTION

The present disclosure is directed to building a platform capable of selecting highly reliable reviews through reviews written by consumers and experts and users' evaluation for these reviews, filtering out malicious advertisements, manipulation of reviews, or the like, and providing consumers accurate information about products or services.

In addition, the present disclosure is directed to a platform capable of ensuring a fair compensation to reviewers through a strict evaluation for reviews and providing financial benefits to review users.

According to an aspect of the present invention, there is provided a system for operating review-and-make-money platform (hereinafter referred to as RAMM) including a review posting unit configured to receive a reviewer review, provide the received reviewer review to a consumer terminal (review user terminal), and display the reviewer review on a review article posting screen of the consumer terminal, a review evaluation unit configured to collect and index a consumer evaluation for the displayed review and manage a review satisfaction (reliability and/or faithfulness) and a reviewer reliability index, and a priority adjustment unit configured to determine exposure ranking for each review article based on at least one of the review satisfaction and the reviewer reliability index managed by the review evaluation unit.

The review posting unit may receive reviews of a producer, a seller, a consumer, and an expert from a producer/seller terminal and a reviewer terminal, classify the received reviews into a producer review, a seller review, a consumer review and an expert review, and provide the classified producer review, seller review, consumer review, and expert review to the consumer terminal (review user terminal).

The review posting unit may provide a convenient UI and connection function for recommending a review article written by a reviewer through SNS to which the same reviewer or others subscribe to support performance of a review sharing function.

The review evaluation unit may collect a consumer evaluation for a review and a consumer evaluation for a product/service from each of the consumer terminals and calculate the review satisfaction and the reviewer reliability index based on the collected consumer evaluations. For example, the evaluations for reviews of individual consumers (review users) who purchase and use products/services through the reviews may be received and collected from each of the consumer terminals, and the review satisfaction and the reviewer reliability index may be calculated based on the received and collected evaluations. The review satisfaction may be an average of a sum of ratings of the individual consumers (review users) who purchase and use products/services through the reviews. The reviewer reliability index may be the average of the sum of the review satisfaction of all the reviews written by the reviewer.

The reviewer reliability index may be determined to be heightened as the consumer satisfaction and the reviewer evaluation for a product/service match or get closer to each other.

The review evaluation unit may collect the review satisfaction and the reviewer reliability indexes determined by individual consumers from each of the consumer terminals to determine the review satisfaction and the reviewer reliability indexes.

The review evaluation unit may adjust the review satisfaction and the reviewer reliability by comparing the purchase inducement degree (for example, the number of purchases generated by the review article) and the user evaluation for the used product/service. When the purchase inducement degree and the evaluation result of the product/service differ by a predetermined range or more, this means that the review is an exaggerated advertisement or a negative advertisement for the product/service, so the reviewer reliability index may be lowered in the primary evaluation.

The review evaluation unit may be configured to primarily evaluate the reviewer reliability based on the purchase inducement degree, update the reliability index by reflecting the buyer evaluation for the used product/service, and lower the reviewer reliability index in the primary evaluation when the purchase inducement degree and the evaluation result of the product/service differ by the predetermined range or more as described above.

The system for operating RAMM may further include a financial processing unit performing all processes on cashable property including a profit calculation, a profit distribution, and a virtual currency operation in a platform.

According to another aspect of the present disclosure, there is provided a method for operating RAMM including collecting one or more reviews from one or more reviewers, recognizing a purchase generated through the reviews, paying compensation per purchase to the reviewer who writes the review, collecting an evaluation result of the review that causes a buyer to purchase, determining a review satisfaction and a reliability index for a reviewer based on the collected evaluation result; and adjusting exposure ranking of the review based on at least one of the review satisfaction and the reliability index.

The determining may include at least one of collecting review satisfaction and reviewer reliability indexes determined by individual consumers from each consumer terminal to determine the review satisfaction and the reviewer reliability index, collecting evaluations for product/services determined by the individual consumers from each consumer terminal and comparing the collected evaluations with a reviewer evaluation for the product/services to determine the review satisfaction and the reviewer reliability index, collecting the evaluations for the product/services determined by the individual consumers from each consumer terminal and comparing the collected evaluations with the reviewer evaluation for the product/services to determine a primary review satisfaction and summing the primary review satisfaction with a purchase incentive degree to determine a secondary review satisfaction and the reviewer reliability index, comparing the purchase inducement degree with a buyer evaluation for a used product/service, and lowering the review satisfaction and the reviewer reliability index in a primary evaluation when the purchase inducement degree and a result of the buyer evaluation for the product/service differ by a predetermined range or more, and primarily evaluating the reviewer reliability based on the purchase inducement degree, updating the reliability index by reflecting the buyer evaluation for the used product/service and lowering the reviewer reliability index in the primary evaluation when the purchase inducement degree and the evaluation result of the product/service differ by the predetermined range or more.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a basic conceptual diagram of a RAMM according to the present disclosure;

FIG. 2 is a core functional diagram of the RAMM according to the present disclosure;

FIG. 3 is a diagram illustrating a flow of review evaluation performed by the RAMM according to the present disclosure;

FIGS. 4A and 4B illustrate evaluation results for reviews and reviewers according to the present disclosure;

FIG. 5 is a diagram illustrating an example of a list of reviews and individual reviews provided by the RAMM according to the present disclosure;

FIG. 6 is a correlated conceptual diagram illustrating a RAMM system according to the present disclosure and a terminal connected thereto; and

FIG. 7 is a structural diagram of the RAMM according to the present disclosure.

### DETAILED DESCRIPTION OF EXEMPLARY EMBODIMENTS

The objects and effects of the present disclosure are not limited to those described above, and the objects and effects of the present disclosure, and technical configurations for achieving them will become apparent with reference to the embodiments described later in detail together with the accompanying drawings.

In describing the present disclosure, when it is determined that a detailed description of a known function or configuration may unnecessarily obscure the subject matter of the present disclosure, the detailed description thereof will be omitted. In addition, the present disclosure is not limited to the embodiments disclosed below but may be implemented in various different forms. Each embodiment described below is provided to ensure that the disclosure of the present disclosure is complete and completely inform the scope of the invention to those with ordinary knowledge in the technical field to which the present disclosure belongs and is not intended to limit the scope of the present disclosure.

On the other hand, in each embodiment of the present disclosure, each component, functional block, or means may be constituted by one or more sub-components, and electrical, electronic, and mechanical functions performed by each component may be implemented with various known devices or mechanical elements such as electronic circuits, integrated circuits, and an application specific integrated circuit (ASIC) and may be implemented separately or two or more thereof may be integrated into one.

Hereinafter, a configuration and operation of a RAMM according to the present disclosure will be described in detail with reference to the accompanying drawings.

<Basic Concept of RAMM Service>

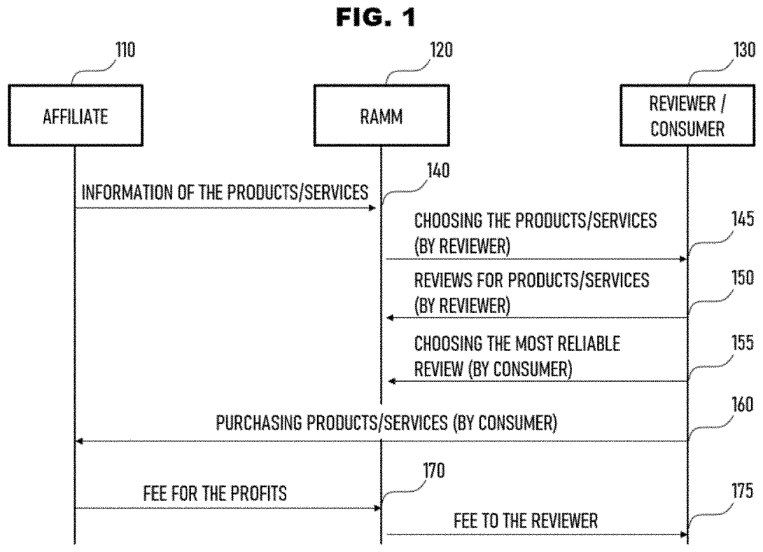

FIG. 1 is a basic conceptual diagram of a RAMM according to the present disclosure. As illustrated, RAMM is a platform that allows reviewers to review products and services of affiliates and allows consumers who purchase the products/services through the review to evaluate reviews that have influenced their purchases after use to filter out exaggerated advertisements or false reviews.

In addition, reviewers receive compensation for their own review, and the RAMM evaluates and discloses the review/reviewer reliability so that this compensation becomes a fair compensation.

In other words, the RAMM is an Internet platform that connects “affiliates (producer, seller, and the like) and reviewers” and “affiliates and consumers”. Reviewers include a consumer and an expert. In other words, the consumer may be the reviewer. The expert is a person with specialized knowledge and/or rich experience in a function, a structure, usability, and feasibility of a product/service and includes a purchasing expert, a professional marketer, a popular blogger, a professional SNS user, a repair engineer, a barista, a sommelier, a critic, a scholar, a professor, or the like.

In addition, the products/services described in the present disclosure encompass not only products provided for convenience and various services such as education, errands, and haircuts, but also all products consumed by the modem public such as education, reviews, articles, and books.

The relationship between the RAMM 120, the affiliate 110, and the reviewer 130 is as follows.

First, the affiliate provides information (URL) of products or services to the RAMM and pays a fee per case to the reviewer when the products or services are sold through reviews posted on RAMM.

The reviewer chooses the products or services posted on RAMM, leaves a review for the chosen products or services, and receives a fee per case when a consumer makes a purchase through the reviewer review.

The detailed process is as follows. At 140 the affiliate provides the information (URL) of the products or services to the RAMM. At 145 the reviewer chooses the products or services provided to the RAMM. At 150 the reviewer leaves accurate and honest reviews for the products or services that he/she chooses in the RAMM. In this case, ‘BUY’ buttons for the products or services are created, and URLs of affiliates are linked to the ‘BUY’ buttons. At 155, when pressing the ‘BUY’ button of the most reliable reviews among the generated reviews, consumers are connected to an affiliate through the URL linked to the ‘BUY’ button. At 160, consumers purchase products or services from the affiliate. As a result, profits are generated for the affiliate. At 170 the affiliate pays a fee for the profits to the RAMM. At 175 the RAMM pays a fee excluding a relay fee to the reviewer. The ‘BUY’ button that is generated when the reviewer leaves the review includes the information about the reviewer, so it is possible to accurately identify which reviewer review a consumer has seen to make a purchase.

In addition, the consumer may evaluate the review after the actual use of the purchased product/services. Whether the actual feeling of using the product/services is different from the contents of the review or not, the review can be evaluated.

The RAMM recommends that consumers (review users) evaluate the reviews after the consumers actually use the purchased product/services so that an actual buyer's evaluation for review articles is boosted. To this end, a predetermined virtual currency or points may be paid to people who participated in the review evaluation, or people may receive the virtual currency or points in cash or use the virtual currency or points like cash in affiliates.

In the above process, the RAMM calculates the reliability of reviews and reviewers based on the evaluation results of consumers. As another embodiment, the RAMM may be configured to evaluate the reliability of reviews and reviewers based on the purchase result and reflect the re-evaluation results to update the reliability of the reviews and reviewers.

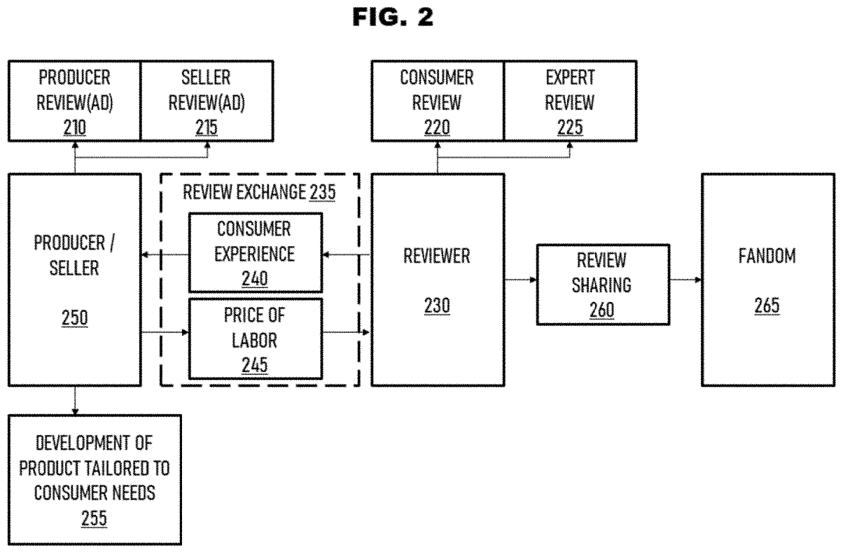

As described above, the basic structure of the RAMM is schematically represented as [affiliate=producer OR seller] and [reviewer=consumer OR expert], but in reality, as illustrated in FIG. 2, all of these are reviewers in the RAMM. In other words, all of the producer, seller, consumer, and expert are reviewers.

When a purchaser or buyer searches for products or services through an RAMM app, [producer review], [seller review], [consumer review], and [expert review] appear on a screen. The RAMM guides producers and sellers to conduct review type advertisements, that is, honest advertisements, rather than exaggerated advertisements. In addition, the RAMM may allow a buyer to evaluate the [producer review] and [seller review]. For reviews (ads) of producers/sellers with high overall evaluation results, compensation measures such as lowering advertising costs, increasing exposure rankings, or combining these are taken to guide producers/sellers to conduct honest advertisements.

As such, the RAMM treats producers/sellers and their advertisements as reviewers/reviews in terms of “strict evaluation and fair compensation for reviews”.

However, in order to avoid confusion with reviewers/reviews in a general meaning in a trading world, in the following description of this specification, the terms reviewer and review will be described based on those (e.g., consumers, experts) who have reviewed except for the producers/sellers and their reviews.

The RAMM classifies reviewers into two types: active reviewer and passive reviewer. \textcircled{1} The active reviewers are groups of experts who have a contract with the RAMM. The active reviewers include a repair technician, an early adopter, a sommelier, a barista, a critic, etc. These active reviewers are people who consume, evaluate, analyze, and introduce new products in advance.

\textcircled{2} The passive reviewers are ordinary consumers. The passive reviewers are people who leave simple reviews for the products and services they purchase/use, and have a broad base. The reviewers are registered in the RAMM for fee payment and reviewer management.

On the other hand, review users are general members or non-members who have not registered as reviewers in the RAMM and are people who use reviews in the RAMM, purchase products and services through the reviews, evaluate reviewers' reviews, and leave comments. The review users are potential reviewers. Since the RAMM analyzes the evaluation results and comments of the review users to perform a strict evaluation on the reviews, the review users play a key role in the strict evaluation.

FIG. 2 is a core functional diagram of the RAMM according to the present disclosure. With reference to FIG. 2, the operation method of the RAMM will be described in more detail.

The RAMM has two key features. One of the two key features is a “review sharing” function 260, and the other thereof is a “review exchange” function 235.

\textcircled{1} The [review sharing] function 260 is a function of allowing a reviewer 230 to strongly recommend products he/she has reviewed through SNS he or she is a member of. The essence of the review is to inform others of products or services honestly and accurately and to strongly recommend good products or services. The “review sharing” function 260 not only implements the essence of the review but also enables reviewers to secure their own fandom 265. The reviewers 230 constantly communicate with their fandom 265 to make more reliable reviews, which becomes an intangible asset for reviewers 230.

\textcircled{2} The [review exchange] 235 is a marketplace to utilize the intangible assets of the reviewers created in this way without destroying the intangible assets. The “review exchange” 235 is divided into two areas: a [producer/seller] area and a [reviewer (consumer/expert)] area. For example, when the producer/seller needs a reviewer who participates in the production of the review advertisement or products, the producer/seller may announce the reviewer in a “review exchange” [reviewer (consumer/expert)] column. In this case, reviewers 230 may bid, and producers/sellers may bid among the bidders. On the other hand, among the reviewers (consumers/experts) 230, those who want to participate in the production of the review type advertisements or products may be announced in the “review exchange” [reviewer (consumer/expert)] column. In this case, conversely, the producers/sellers choose from among them. When the successful bid is made between the producer/seller and the reviewer, a transaction is made and the RAMM receives a certain portion of a transaction amount as a relay fee.

The RAMM receives advertising fees for “producer reviews (ads)” 210 and “seller reviews (ads)” 215 that are posted. Alternatively, the RAMM receives a relay fee per sale, not an advertisement fee. In these two cases, a sale is not performed through the reviewers, and therefore the entire fee is for the RAMM.

<Strict Evaluation>

Since all the reviews are not valid or reliable, it is very important for an appropriate evaluator to strictly evaluate the reviews to ensure the reliability of the review.

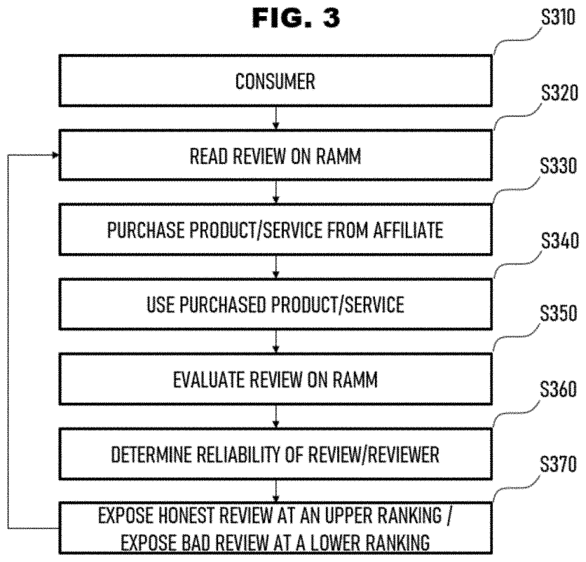

The RAMM according to the present disclosure takes the evaluation method as illustrated in FIG. 3 for the strict evaluation.

The characteristics of the method of evaluating the RAMM reviews are as follows.

At S310, the reliability of the review in the RAMM is not evaluated by a few central judges or AI but is evaluated by consumers who purchase/use the products or services through the review.

The evaluation method allows the RAMM to determine the reliability of the review/reviewer at S360 when the consumers read the review at S320, purchase and use the products/services at S330, S340, and then evaluate the review that causes the purchases at S350.

At S370 according to the evaluation results, the RAMM adjusts the exposure ranking of reviews for each product/service so that honest reviews and reviewers are exposed at the top, and bad reviews and reviewers are exposed at the bottom. The reviews and reviewers exposed at the top are recognized as “reliable reviews or reviewers” by consumers, and therefore, as this virtuous cycle is repeated, the honest reviews are more frequently exposed to consumers and used, while the bad reviews are naturally expelled. In this virtuous cycle, the consumers may find and use the products or services they want faster and more accurately. In addition, since the accurate evaluation for the products and services is made through the honest reviews, the sales of good products and services increase, and bad products and services are expelled.

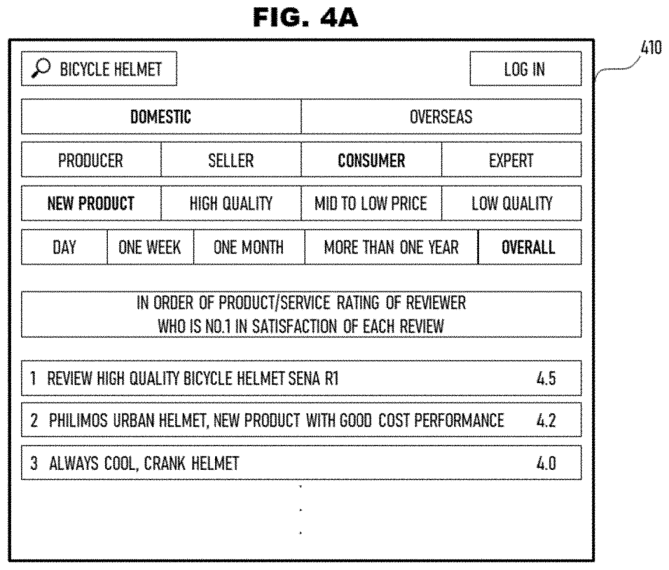

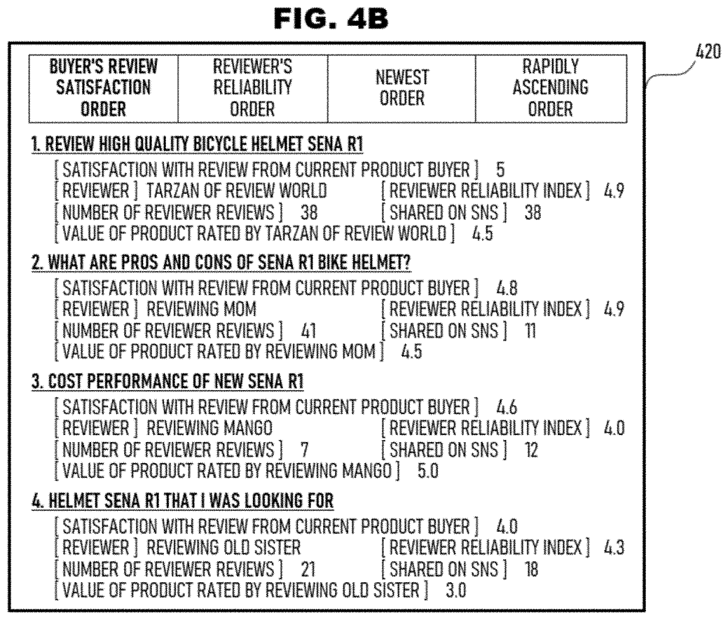

The review evaluation will be described in more detail with reference to FIG. 4.

Looking at screen 410 in FIG. 4A, several reviews on a bicycle helmet are expressed. One or more reviews that meet the criteria (new product, consumer review rating, etc.) are displayed in an exposure ranking determined by the RAMM.

In this case, it should be noted that the rating displayed on the right side of each review is not the consumer rating or reviewer rating for the products/services but is the consumer rating for the reviewer review.

For example, the rating displayed on the right side of each review is not the consumer rating or a summed rating for the reviewers for the products/services but a rating for the products/services of the reviews that is evaluated No. 1 in satisfaction by review users.

There is always the possibility that the evaluation within the review for the product/service will be inaccurate. Since actual consumers who purchase a product generally tend to give generous ratings and there may be reviewers who review falsely such as by overestimation or underestimation, there is a high possibility that the review itself is not the accurate evaluation for the product/service.

Therefore, the RAMM according to the present disclosure gives ratings to reviews based on the review satisfaction of consumers who purchase products or services through reviewers. For the same product/service, the rating given to the product or service by the reviewer who is ranked No. 1 in the review ranking becomes the final rating for the product or service.

The more honest the review, the higher the satisfaction of consumers. For example, a rating for a product by a reviewer who reviews Sena R1 (model name of bicycle helmet), which is ranked No. 1 in the rating on the screen 410 in FIG. 4A, is 4.5 points. All the reviews appearing on the screen 410 are reviews selected as No. 1 in the review satisfaction by buyers in each product area. In the review that is ranked No. 1 for each product, the Sena R1 receives a rating of 4.5, an urban helmet receives a rating of 4.2, and a crank helmet receives a rating of 4.0.

As many people purchase products and services using the RAMM and data is accumulated, the ratings and evaluations for the products/services by the reviewer, which are posted on the RAMM, converge on the general product/service satisfaction of consumers.

The exposure ranking of reviews for each product is determined as follows.

Screen 420 in FIG. 4B is a screen that is displayed when a specific product “Sena R1” in the screen 410 in FIG. 4A is touched (clicked) and displays a result of reviewing the “Sena R1” and giving a rating to the reviewed “Sena R1” by various reviewers. Among them, the review with the highest satisfaction by buyers is a review written by “Tarzan of the review world”. In other words, it means that the reviewer “Tarzan of the review world” evaluates and rates this product most accurately. The rating that the reviewer “Tarzan of the review world” gives to this product is 4.5 points, which is reflected on a first screen after searching on the screen 410.

Looking at the screen 420 in FIG. 4B again, it is assumed that the rating that consumers give the “Sena R1” after purchasing and using the “Sena R1” is 4.5. Reviewer No. 3 “Review Mango” is rated 5.0, which corresponds to overestimation. Of course, buyers give low ratings to the review satisfaction of the reviewer “Review Mango.” Reviewer No. 4 “Reviewing older sister” is rated 3.0, which corresponds to underestimation. Similarly, buyers give low ratings to the reviewer Reviewing sister's review satisfaction. The average review rating, which is the sum of ratings for reviews, becomes the reliability of reviewers.

Therefore, the overestimation or the malicious underestimation leads to the decrease in the reliability of the reviewer. As the reliability of the reviews and reviewers decreases, the exposure ranking decreases, which leads to the decrease in the fee income of the reviewer.

On the other hand, those who perform accurate and honest reviews increase their reliability, which leads to the increase in the exposure ranking and the tangible and intangible benefits for the reviewer.

The RAMM gives reviewers the freedom to post reviews freely, and the reviews are evaluated by buyers, not by the RAMM. The RAMM provides a system where honest and reliable reviewers make a lot of money, and dishonest reviewers are expelled.

On the other hand, the rating for the product/service of Reviewer No. 2 “Review Mom” on the screen 420 in FIG. 4B, is 4.5 points, which is the same as the reviewer “Tarzan of the review world” which is No. 1. In other words, the evaluation accuracy of the reviewer “Review Mom” is evaluated appropriately as joint No. 1, but as the buyer's review satisfaction for the current product is higher for the reviewer “Tarzan of the review world”, therefore, the reviewer “Tarzan of the review world” is selected as the top priority reviewer for the Senor R1. That is, in the present embodiment, the review satisfaction and the reviewer reliability are evaluated by the consumer, and among them, the review satisfaction is taken as a priority criterion. The review satisfaction is due to the reviewer reliability and the review faithfulness (specificity and ease of understanding of product introduction, etc.) all being reflected.

As described above, in a preferred embodiment according to the present disclosure, individual consumers may determine review satisfaction and reviewer reliability index for a specific review and RAMM collects the determined review satisfaction and reviewer reliability index to determine the review satisfaction and reviewer reliability index for the review and reviewer as the average (arithmetic average, weighted average, geometric average, etc.).

Another embodiment may be performed in a manner in which a buyer evaluates only the product/service satisfaction to reduce inconvenience to the buyer, and the review satisfaction and reviewer reliability index is determined by the RAMM by comparing the overall evaluation results of the buyer's product/service satisfaction with the reviewer's evaluation for the product/service. Even in this case, the buyer's review satisfaction is used as the first criterion for determining the exposure ranking.

Another embodiment may be performed in a manner in which the review satisfaction and reviewer reliability index are determined by the RAMM by comparing the overall evaluation results of the buyer's product/service satisfaction with the reviewer's evaluation for the product/service, and the buyer evaluates only the review satisfaction to reduce the inconvenience to the buyer. Even in this case, the buyer's review satisfaction is used as the first criterion for determining the exposure ranking.

Another embodiment may be performed in a manner in which the buyer evaluates only the product/service satisfaction, and the RAMM compares the evaluated product/service satisfaction with the reviewer's evaluation for the product/service to determine a primary review satisfaction and adds the purchase inducement degree (the number of times the buyer makes a purchase after viewing a review, or an index calculated based on the number of times) to the primary review satisfaction to determine the secondary review satisfaction and the reviewer reliability index. Even in this case, the buyer's review satisfaction is used as the first criterion for determining the exposure ranking.

As another embodiment, when the review satisfaction and reliability index differ by a predetermined range or more, the reliability index may be used as the first criterion for determining the exposure ranking. Alternatively, the reviewer reliability index may be adjusted.

Alternatively, there is a method of performing the primary evaluation with the purchase inducement degree and updating the reliability index by reflecting the evaluation for the product/service after the use by the buyer. In this case, when the purchase inducement degree and the evaluation results of the product/service differ by a predetermined range or more, a penalty is imposed on the reviewer's reliability with the evaluation result of the product/service or less to lower the rating.

On the other hand, there may be cases in which the intentional or unintentional evaluation error has occurred for the corresponding product/service while a professional reviewer writes a review based on their expertise in the product/service area. In this case, the difference between the review satisfaction and reliability index may be greater than a predetermined threshold. When such cases increase, professional reviewers may manipulate an evaluation for specific products/services to distort reviews.

As a complementary measure for the occurrence of the distortion, the method of allowing the RAMM to determine the reliability index and determine the exposure ranking based on the determined reliability index is employed to prevent the intentional distortion of the professional reviewers.

In this embodiment, the method in which the RAMM determines the reliability index compares the purchase inducement degree of the review with the product/service evaluation after the use by the buyer to give a penalty to the review satisfaction and the reviewer satisfaction when the purchase inducement degree and the evaluation results of the product/service differ by the predetermined range or more, thereby lowering the rating. In this case, it is possible to suppress substantial advertisements to consumers due to the brilliant writing skills of the professional reviewers.

On the other hand, as the method in which the RAMM determines the reliability index, there is a method of performing the primary evaluation with the purchase inducement degree and updating the reliability index by reflecting the evaluation for the product/service after the use by the buyer. In this case, when the purchase inducement degree and the evaluation results of the product/service differ by a predetermined range or more, the reviewer reliability index is lowered the evaluation result for the product/service or less. In this case, it is possible to suppress substantial advertisements to consumers due to the brilliant writing skills of the professional reviewers.

<Fair Compensation>

On the other hand, the RAMM has a structure in which continuous profit may be generated for the reviewer and platform, respectively, for the fair compensation for active participation of reviewers and the stability of platform operation.

Hereinafter, this will be described in detail with reference to Table 1 below, and it should be understood that Table 1 and the following description of the profit rate are only examples and may be set differently.

TABLE 1

| Profit | | |
|---|---|---|
| Purchase path | RAMM | Reviewer |
| Producer review (ad) | Advertising cost or | 0% |
| | 5% per case | |
| Seller review (ad) | Advertising cost or | 0% |
| | 5% per case | |
| Purchase through reviewer | 2% per case | 3% per case |

Reviewers earn 3% of each case when the purchase is made through their reviews. A reviewer's profit flow may be a form in which a reviewer directly receives a profit from producers/sellers or in a form in which a reviewer receives a usage fee that producers/sellers pay to the RAMM.

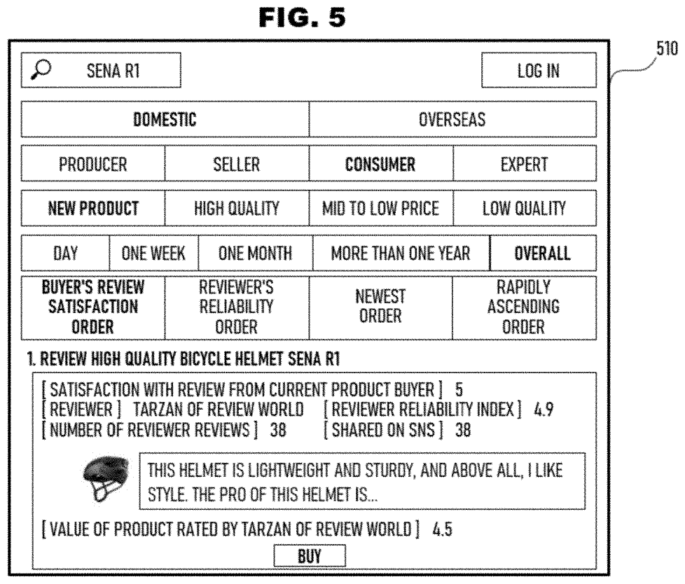

To check whether or not a purchase is generated through a specific reviewer review and to count the number of times of purchases, as illustrated in FIG. 5, the RAMM may provide a ‘BUY’ button at the bottom of the review article to accurately determine whether the ‘BUY’ button has been clicked and the number of clicks. The URL linked to the ‘BUY’ button may be a URL of a product payment window operated by an affiliate, or the URL of the product payment window operated by the RAMM.

For the stable operation of platform services, the RAMM also makes profits, and as shown in Table 1, may create profits through a total of four areas: [producer review], [seller review], [consumer review], and [expert review].

\textcircled{1} In the case of the “producer review” and “seller review”, when producers and sellers do not directly sell products or services but conduct only the review type advertisements, the RAMM receives advertising fees from the producers and sellers. \textcircled{2} When the producers and sellers sell products and services through their reviews, the RAMM receives a relay fee of 5% from the producers and sellers.

However, when the “producer reviews” and the “‘seller reviews’ also make a direct sale, the reviewer's reliability is evaluated by buyers, so product reviews are listed according to the review satisfaction ranking. When the review satisfaction is 2.0 or less, sales of the product or service are stopped. In this case, the advertising fee or relay fee is not received.

On the other hand, since a method of selling services are various according to their characteristics, the services may not be sold in the above-described method. In that case, the services are sold through reservation, order, purchase, contract, sending to readers, etc. according to the characteristics of each service. Services such as academies, hospitals, restaurants, travel, pensions, insurance, health, beauty, sports, theater, and movies may be changed according to their characteristics.

For example, a “press” service may be operated as follows.

\textcircled{1} The RAMM establishes alliances with each press. \textcircled{2} Each press transmits article information to the RAMM in real time. \textcircled{3} Reviewers write reviews for articles they consider to be the most important among these articles, rate the importance of news, and post the rated importance on the RAMM. \textcircled{4} Consumers read the review, and when the consumers are curious about the contents of articles, the consumers touch (click) [read article] at the bottom of the review. This is connected to an article of the press. \textcircled{5} Consumers consume news in the press, not in the RAMM. \textcircled{6} Consumers return to the corresponding review of the RAMM and rate the importance of news. The first review satisfaction is determined by a difference between a reader's rating for the importance of news and a reviewer's rating for the importance of news. Alternatively, the purchase inducement degree is added to the first review satisfaction to determine the second review satisfaction. The average of the sum of the review satisfaction becomes the reviewer reliability index. Unlike the product review, in the case of news, reviewers are centered on the role of guides. \textcircled{7} Through this process, the “review satisfaction” is determined. \textcircled{8} News of each field is posted on the RAMM in the order of the sum of the ratings of reviewers and readers for the importance of news or in the order of reviewer's reliability. \textcircled{9} This is ultimately determined by news consumers, and therefore \textcircled{10} unfair appropriateness no longer occurs. \textcircled{11} The number of comments on a review means that the review is becoming that much of an issue, and thus, readers may consume news in the order of the number of comments on the review. \textcircled{12} In the case of news reviewers, criticism of bad news is also necessary, and thus, news may be consumed in the order of bad news. Bad news is exposed at the top as the average of the sum of the reviewer's rating for the importance of news and the reader's rating for the importance of news decreases. In the case of news, the reviewer's perspective may be better than the public, so news is not posted in the news column in the order of satisfaction of the review itself. \textcircled{13} Importance of news can be calculated as follows: [Importance of news(five-point scale)]=[reviewer's reliability(five-point scale)+reviewers' rating for the importance of news(five-point scale)+readers' rating for the importance of news(five-point scale)]÷3

The RAMM exposes articles of each press to as many readers as possible through the above process, so the corresponding press earns more advertising profits. For example, assuming that when the RAMM exposes articles of a press to 10 readers, it generates a profit of 100 won for the press, the RAMM receives a certain portion of 100 won from affiliates and takes some of the 100 won as a relay fee and pays some of the 100 won to reviewers.

Alternatively, the RAMM does not send readers to each affiliated press, but the RAMM and the affiliated presses may create a news mirror site and manage the news mirror site jointly. In this case, the RAMM and the affiliated presses may know the exact figures on how many times the readers who access the mirror site of each press have clicked advertisements through the reviewer review, so transparency and fairness in the distribution of profits between the RAMM, the affiliated presses, advertising agencies, and reviewers may be secured.

The most essential element in the RAMM system is to build a trust relationship between the producers and consumers and the sellers and consumers through “reviews”.

\textcircled{1} The success of [RAMM business model] depends entirely on the reliability of the review and the reviewer. The affiliates of the RAMM pay product or service sale fees to reviewers through the RAMM. In addition, the collaboration with reviewers with verified reliability is made for “producer/seller review production” or “product production”. Reviewers are motivated, proud, and passionate as leaders who build a trusting society as well as obtaining financial benefits. Consumption behavior gradually shifts toward C2M (Customer to Manufacturer; producer-to-consumer direct transaction). At that time, consumers purchase products through verified reviewers and reviews, so the role of reviewers is further increased.

\textcircled{2} As the RAMM is actively utilized, the affiliates of the RAMM get benefits such as increased reliability, advertising effect, increased sales, and securing sales territory. In an era where consumers are reviewers and reviewers are consumers, affiliates not only attract all citizens as customers but also sell products and services through verified reviewers, thereby gaining synergistic effects such as increasing corporate affinity, enhancing image, and increasing sales. In addition, since consumers' needs are constantly communicated through reliable reviewers, in particular, producers can efficiently manage resources without wasting resources caused by improper product production. The [review exchange] function of the RAMM is an excellent communication channel for the efficient resource management.

\textcircled{3} Consumers also purchase products and services through verified reviewers and, therefore, are free from consumption or waste due to misjudgment, and from the mischief of famous celebrities and influencers. In addition, the reliability of the reviews of the RAMM increases as time goes by, so consumers may easily find the products and services they want with just a few touches (clicks). The RAMM app allows consumers to find what they want in four clicks and then make a purchase. In addition, when global services are in progress, the RAMM enables consumers to find and reliably purchase products and services around the world in the shortest time.

<Character and Authority of RAMM Member>

RAMM members may each log in to five areas when logging in to the app or web: [Producer login], [Seller login], [Reviewer (individual or corporate) login], and [General member login]. Except for general members, any member in the four areas may post review articles or videos after logging in. As a review user, general members may rate and comment on the products and services they purchased. However, general members do not have the authority as a reviewer.

Reviewers may be individuals as well as corporations. To register as a reviewer, a reviewer needs to prove his/her identity and have a bank account to receive sales fees. For minors, a reviewer may be registered in the presence of a guardian. General members may also sign up anonymously. “Producer” and “seller” members may get detailed information including overall reviewer ranking and history when logging in, may announce review production, product improvement or production related contents through the [review exchange], and may negotiate with reviewers who will participate in the [review exchange]. In addition, “producer” and “seller” members may check the history of reviewers announced on the [review exchange] to sell their talent, knowledge, reliability, and fandom as the reviewers and choose the reviewers to promote their products and services.

Reviewers may access product/service sales information for each affiliate provided to the RAMM and may choose the product/service sales information to freely review the product/service sales information. In addition, reviewers may bid for announced cases by producers or sellers through the [review exchange] and may announce their talents, knowledge, reliability, and fandom to sell.

General members may not access product/service information for each affiliate, may not post reviews, and may not participate in the [review exchange]. However, general members (including producers or sellers) may check the overall reviewer ranking and history, and use a function of designating a specific reviewer. As a result, consumers may create their own list of reviewers by choosing reviewers that suit their tastes and inclinations in various areas and may quickly and easily read the reviews of these reviewers and purchase the products and services at any time. In addition, general members may receive a certain portion of virtual currency or points from the RAMM when evaluating and commenting on the review. General members may use the virtual currency or points from the RAMM like cash in the affiliates of the RAMM.

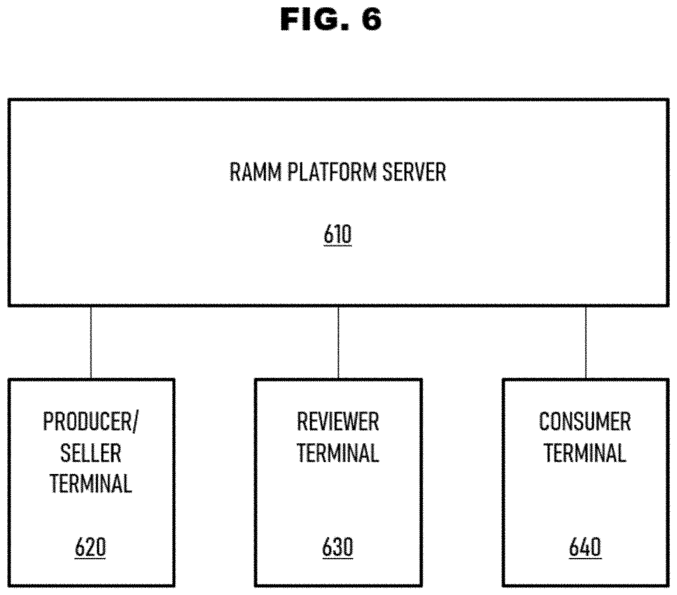

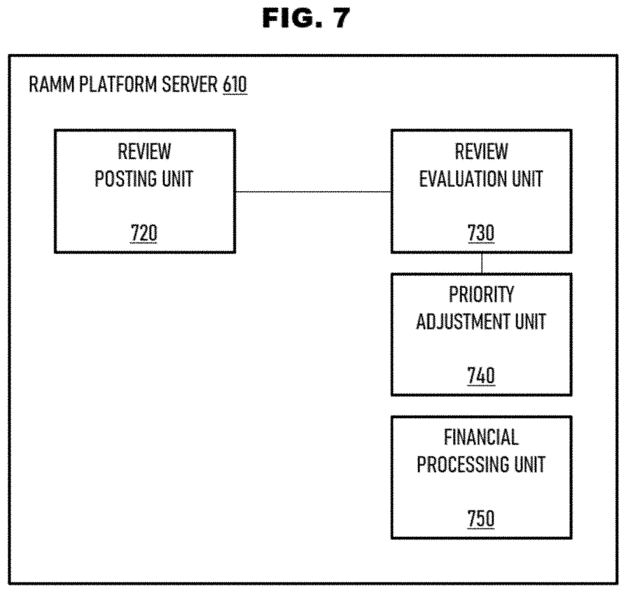

Hereinafter, the structure of the RAMM system according to the present disclosure will be described with reference to FIGS. 6 and 7.

As illustrated in FIG. 6, the RAMM system according to the present disclosure is configured to include a RAMM server 610 and is linked with a producer/seller terminal 620, a reviewer terminal 630, and a consumer terminal 640.

The RAMM server 610 performs review collection/posting, evaluation, compensation, financial processing (profit distribution, internal virtual currency operation) for operating the RAMM, and the producer/seller terminal 620, the reviewer terminal 630, and the consumer terminal 640 access the server 610 based on a mobile app or web to perform tasks of searching for reviewers, writing and uploading reviews, and reading and evaluating reviews.

As illustrated in FIG. 7, the RAMM server 610 includes a review posting unit 720, a review evaluation unit 730, a priority adjustment unit 740, and a financial processor unit 750.

In this specification, when “˜ unit”, “˜ module”, and “˜ means” are functionally described or limited like the description of the following review posting unit 720, review evaluation unit 730, priority adjustment unit 740, and financial processor unit 750, the described stated “˜ unit”, “˜ module”, and “˜ means” may be implemented as one H/W or two or more individual H/Ws. In addition, some or all of the functions of one “˜ unit”, “˜ module”, and “˜ means” may be performed by being merged into one or more other “˜ units”, “˜ module”, and “˜ means”.

That is, the review posting unit 720, the review evaluation unit 730, the priority adjustment unit 740, and the financial processor unit 750 of the present specification are used to enhance understanding of the technical idea of the present disclosure and to facilitate explanation and are not used to limit the type of H/W configuration in which these functions will be implemented.

The review posting unit 720 receives reviews from producers, sellers, consumers, and experts from the producer/seller terminal 620, the reviewer terminal 630, and the consumer terminal 640, classifies the reviews into [producer review], [seller review], [consumer review], and [expert review] and provides the classified [producer review], [seller review], [consumer review], and [expert review] to the app or web of the consumer terminal 640.

In addition, the review posting unit 720 performs or supports the above-described “review sharing” function 260, and “review exchange” function 235.

Specifically, the review posting unit 720 may provide a convenient UI and connection function for recommending a review article written by a reviewer through SNS to which the reviewer subscribes to support the performance of the review sharing function. When the review posting unit 720 shares reviews, the review posting unit 720 may manage the shared SNS link to make a purchase after seeing the reviews posted on the relevant SNS, so the profit distribution may be made more accurately based on this information.

To support the review exchange function, the review posting unit 720 supports announcing the fact that producers/sellers need reviewers to participate in the production of review advertisements or products in the producer/seller column. In this case, reviewers may bid through the review posting unit 720.

Conversely, for reviewers who want to participate in the review type advertisement production or product production among reviewers (consumers/experts), the review posting unit 720 may announce the reviewers in the reviewer (consumer/expert) column and enable producers/sellers to choose the reviewers.

The review evaluation unit 730 evaluates reviews and reviewers. Individual consumers determine the satisfaction of the reviews and the review evaluation unit 730 collects the determined satisfaction to determine the reviewer reliability index with average (arithmetic average, weighted average, geometric average, etc.) values. Basically, the reviewer reliability index may be determined to be heightened as the consumer satisfaction and the reviewer evaluation for a product/service match or get closer to each other.

In addition, consumer evaluations for reviews and consumer evaluations for products/services are received and collected from each consumer terminal 640, and the review satisfaction and reliability index are calculated based on the received and collected consumer evaluations and consumer evaluations.

The review satisfaction and reliability index may be calculated in various ways as described above.

The priority adjustment unit 740 determines the exposure priority of the reviews. The review with the highest review satisfaction is adjusted to be positioned at the top of the review display screen of the app or web of the consumer terminal 640. The review with the highest reviewer reliability may be adjusted to be positioned at the top.

As another embodiment, when the review satisfaction and reliability index differ by a predetermined range or more, the reliability index may be used as the first criterion for determining the exposure ranking to determine the exposure priority.

On the other hand, professional reviewers may manipulate an evaluation for specific products/services to distort reviews. As a complementary measure for the occurrence of the distortion, the method of allowing the review evaluation unit 730 to determine the reliability index and determine the exposure ranking based on the determined reliability index is employed to prevent the intentional distortion of the professional reviewers.

The financial processor unit 750 performs all processes on cashable property such as a profit calculation, a profit distribution, and a virtual currency operation in the platform.

Hereinafter, a method of operating the RAMM according to the present disclosure will be described based on the above description.

The operating method according to the present disclosure is to collect one or more reviews from one or more reviewers, recognize purchases generated through the reviews, and pay compensation per purchase to the reviewer who writes the review.

In addition, the buyer evaluates the reviews that cause the purchase, determines the review satisfaction and reviewer reliability index for the reviewer, and as a result enables RAMM to adjust the exposure ranking of the corresponding review based on at least one of the review satisfaction and reviewer reliability index.

In the determining, the review satisfaction and reviewer reliability index determined by individual consumers may be collected from each of the consumer terminals to determine the review satisfaction and reviewer reliability index, and unlike this, the reviewer's reliability may be primarily evaluated based on the purchase inducement degree, the reliability index may be updated by reflecting the evaluation for the product/service after the use by the buyer, and the reviewer reliability index may be lowered in the primary evaluation when the purchase inducement degree and the evaluation result of the product/service differ by a predetermined range or more.

The purchase inducement degree may be set based on the number of times the purchase is made through a review article. In addition, the purchase inducement degree of reviews with a great deal of SNS exposure may be adjusted to increase in consideration of the exposure degree of SNS. For example, when the SNS exposure of the specific review is higher than the average exposure of SNS of the RAMM, the purchase inducement degree may be adjusted to increase by the ratio of the SNS exposure and the average SNS exposure for that review.

Alternatively, it is possible to determine the review satisfaction and reviewer reliability by comparing the product/service rating of individual consumers and the product/service rating of reviewers, determine the first review satisfaction by comparing the product/service rating of individual consumers and the product/service rating of reviewers, determine the secondary review satisfaction and reviewer reliability by adding the purchase inducement degree to the determined primary review satisfaction, and update the review satisfaction and reviewer reliability index by comparing the purchase inducement degree and the buyer evaluation for the product/service.

According to the present disclosure, it is possible to evaluate reviewers and the value of reviews with high reliability by providing a platform that ensures a strict evaluation and a fair compensation for reviews of products and services that consumers want to purchase.

It is possible to provide a review platform that does not operate in the form of “customized recommendations” using AI but operates based on the ranking of reviewers and review reliability evaluated by the collective intelligence of actual buyers.

As a result, a “consumer-centric” value chain can be formed. Therefore, consumers can reduce costs such as time and energy to purchase and wrong purchases, reviewers can receive a fair compensation, and producers/sellers can easily obtain information to identify consumer needs and sell excellent products through the obtained information to increase sales.

The configuration of the present disclosure has been described in detail above with reference to some embodiments. However, this is only an example, and of course, various modifications and changes can be made within the scope of the technical idea of the present disclosure. Therefore, the scope of the present disclosure should be defined by the following description of the claims.

What is claimed is:

1. A system for operating review-and-make-money platform, comprising:
a review posting unit configured to receive a reviewer review, provide the received reviewer review to a consumer terminal, and display the reviewer review on a review article posting screen of the consumer terminal;
a review evaluation unit configured to collect and index a consumer evaluation for the displayed review, and manage a review satisfaction and a reviewer reliability index; and
a priority adjustment unit configured to determine exposure ranking for each review article based on at least one of the review satisfaction and the reviewer reliability index managed by the review evaluation unit.

2. The system of claim 1, wherein the review posting unit receives reviews of a producer, a seller, and an expert from a producer/seller terminal and a reviewer terminal, classifies the received reviews into a producer review, a seller review, and an expert review, and provides the classified producer review, seller review, and expert review to the consumer terminal.

3. The system of claim 1, wherein the review posting unit provides a convenient UI and connection function for recommending a review article written by a reviewer through SNS to support performance of a review sharing function.

4. The system of claim 1, wherein the review evaluation unit receives and collects a consumer evaluation for a review and a consumer evaluation for a product/service from each consumer terminal, and calculates the review satisfaction and the reviewer reliability index based on the received and collected consumer evaluation and consumer.

5. The system of claim 1, wherein the review evaluation unit collects review satisfaction determined by individual consumers from each consumer terminal to determine the reviewer reliability index.

6. The system of claim 1, wherein the review evaluation unit determines that at least one of the review satisfaction and the reviewer reliability index becomes higher as a consumer satisfaction and a reviewer evaluation for a product/service match or approach each other.

7. The system of claim 1, wherein the review evaluation unit compares a consumer satisfaction and a reviewer evaluation for a product/service to determine a primary review satisfaction, and sums the primary review satisfaction with a purchase incentive degree to determine a secondary review satisfaction and the reviewer reliability index.

8. The system of claim 1, wherein the review evaluation unit compares a purchase incentive degree and a buyer evaluation for a used product/service, and lowers the reviewer review satisfaction and the reviewer reliability index when the purchase inducement degree and the evaluation result of the product/service differ by a predetermined range or more.

9. The system of claim 1, further comprising a financial processing unit configured to perform all processes on cashable property including a profit calculation, a profit distribution, and a virtual currency operation in a platform.

10. A method for operating review-and-make-money platform, comprising:
collecting one or more reviews from one or more reviewers;
recognizing a purchase generated through the reviews;
paying compensation per purchase to the reviewer who writes the review;
collecting an evaluation result of the review that causes a buyer to purchase;
determining a review satisfaction and a reliability index for a reviewer based on the collected evaluation result; and
adjusting exposure ranking of the review based on at least one of the review satisfaction and the reliability index.

11. The method of claim 10, wherein the determining includes at least one of:
collecting review satisfaction and reviewer reliability indexes determined by individual consumers from each consumer terminal to determine the review satisfaction and the reviewer reliability index;
collecting evaluations for product/services determined by the individual consumers from each of the consumer terminals and comparing the collected evaluations with a reviewer evaluation for the product/services to determine the review satisfaction and the reviewer reliability index;
collecting the evaluations for the product/services determined by the individual consumers from each of the consumer terminals and comparing the collected evaluations with the reviewer evaluation for the product/services to determine a primary review satisfaction and summing the primary review satisfaction with a purchase incentive degree to determine a secondary review satisfaction and the reviewer reliability index;
comparing the purchase inducement degree with and a buyer evaluation for a used product/service, and lowering the review satisfaction and the reviewer reliability index in a primary evaluation when the purchase inducement degree and a result of the buyer evaluation result for the product/service differ by a predetermined range or more; and
primarily evaluating the reviewer reliability based on the purchase inducement degree, updating the reliability index by reflecting the buyer evaluation for the used product/service and lowering the reviewer reliability index in the primary evaluation when the purchase inducement degree and the evaluation result of the product/service differ by the predetermined range or more.
